(19) United States
(12) Patent Application Publication
(10) Pub. No.: US 2017/0169551 A1
(43) Pub. Date: Jun. 15, 2017

(54) IMAGE SHARPENING METHOD BASED ON GRADIENT VALUE AND GRADIENT DIRECTION AND ELECTRONIC APPARATUS THEREOF

(71) Applicants: Le Holdings (Beijing) Co., Ltd., Beijing (CN); LeCloud Computing Co., Ltd., Beijing (CN)

(72) Inventors: Fan Yang, Beijing (CN); Yang Liu, Beijing (CN); Yangang CAI, Beijing (CN); Maosheng Bai, Beijing (CN); Wei Wei, Beijing (CN)

(21) Appl. No.: 15/247,576

(22) Filed: Aug. 25, 2016

Related U.S. Application Data
(63) Continuation of application No. PCT/CN2016/088692, filed on Jul. 5, 2016.

(30) Foreign Application Priority Data
Dec. 10, 2015 (CN) 201510918068.2

(51) Int. Cl. G06T 5/20; G06T 7/00; G06T 5/00

(52) U.S. Cl. CPC G06T 5/20; G06T 5/003; G06T 7/0085; G06T 2207/20012

(57) ABSTRACT

The embodiment of the present disclosure discloses an image sharpening method and based on gradient value and gradient direction and an electronic apparatus thereof. Scan pixel points in an image one by one and calculate gradients of the pixel points; sharpen the pixel points if determine the gradient is larger than a predetermined gradient threshold value, update pixel values of the pixel points with pixel values obtained from the sharpening. Effectively eliminate the perceptible gray scale mutation and also self-adaptively adjust the degree of the image sharpening.

### CROSS REFERENCE TO RELATED APPLICATIONS

This application is a continuation of International Application No. PCT/CN2016/088692, filed on Jul. 5, 2016, which is based upon and claims priority to Chinese Patent Application No. 201510918068.2, filed on Dec. 10, 2015, the entire contents of which are incorporated herein by reference.

### TECHNICAL FIELD

The disclosure relates to an image processing field, particularly regarding to an image sharpening method based on a gradient value and a gradient direction and an electronic apparatus thereof.

### BACKGROUND

Image sharpening is compensation of contours of images, improves the edge jump and gray-scale jump parts of the image, to make the image become clearer, and divided into two types, the spatial processing and the frequency-domain processing.

The unsharp masking (USM) algorithm is a conventional image sharpening algorithm, can make the blurry edge in the image relative clearer. Its principle is taking the difference between the original image and the more blurry image as a mask, adding a value of the mask image according to a predetermined ratio to the original image to realize the image edge sharpening. However, this algorithm has certain defect, the maximum value and the minimum value after sharpening are over the range of the original image, causing a perceptible gray scale mutation at two sides of the edge.

Therefore, a new sharpening algorithm is in need.

### SUMMARY

An embodiment of the present disclosure provides an image sharpening method and electronic apparatus based on gradient value and gradient direction and electronic apparatus, to solve the defect that the maximum value and the minimum value after sharpening are over the original value and cause a perceptible gray scale mutation.

An embodiment of the present disclosure provides an image sharpening method and electronic apparatus based on gradient value and gradient direction, including:

scanning pixel points in an image one by one and calculating a gradient of the pixel points;

sharpening the pixel points if determining the gradient is larger than a predetermined gradient threshold value, and updating pixel values of the pixel points with pixel values obtained from the sharpening.

An embodiment of the present disclosure provides a non-volatile computer storage medium storing computer-executable instructions, and the computer-executable instructions can carry out the gradient value and gradient direction based image sharpening method in any one of the embodiments of the present disclosure.

An embodiment of the present disclosure further provides an electronic apparatus, including: at least one processor; and a memory; wherein, the memory stores procedures which are executable by the at least one processor, the instructions are executed by the at least one processor, so that the at least one processor can execute the gradient value and gradient direction based image sharpening method in any one of the embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technical flow chart in accordance with an embodiment of the present disclosure;

FIG. 2 is another technical flow chart in accordance with an embodiment of the present disclosure;

FIG. 3 is a schematic view of a gradient direction and neighboring pixel points in accordance with an embodiment of the present disclosure;

FIG. 4 is a schematic view of a Gaussian function in accordance with an embodiment of the present disclosure;

FIG. 5 is a structural schematic view of an apparatus in accordance with another embodiment of the present disclosure; and

FIG. 6 is a structural schematic view of an electronic apparatus in accordance with another embodiment of the present disclosure.

### DETAILED DESCRIPTION

For the purpose, technical solutions, and advantages of the present disclosure will become clearer, the followings combine figures and particular embodiments of the present disclosure to further described the present disclosure in detail. Obviously, the embodiments described are a part of the embodiments in the present disclosure but not all embodiments.

### First Embodiment

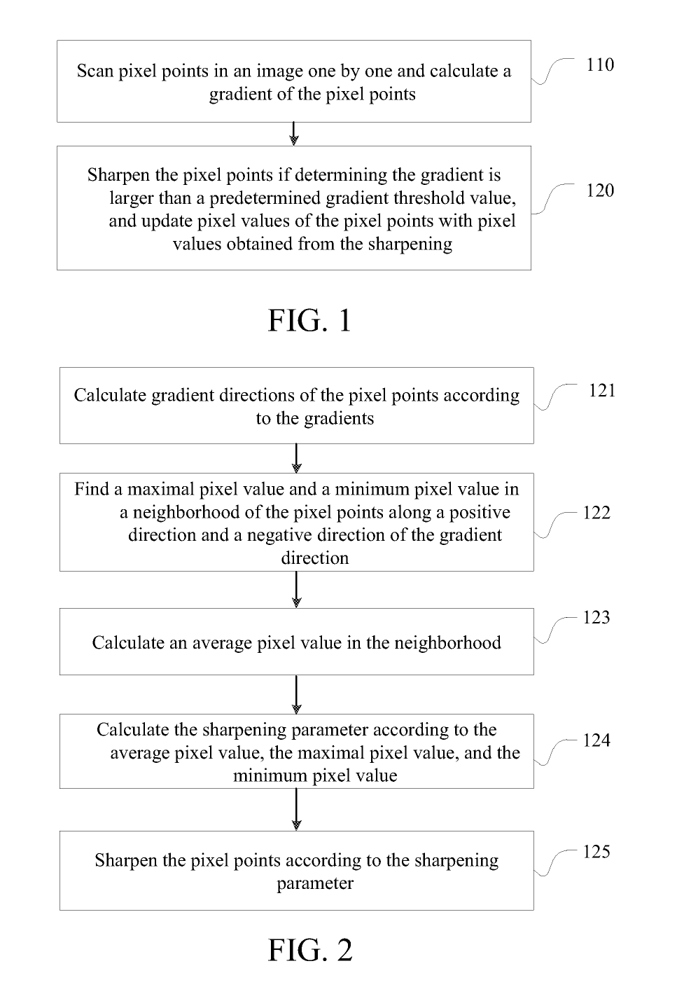

FIG. 1 is a technical flow chart in accordance with an embodiment of the present disclosure, combining FIG. 1, the embodiment of the present disclosure is an image sharpening method and electronic apparatus based on gradient value and gradient direction, mainly implemented by two big steps:

Step 110: scan pixel points in an image one by one and calculate a gradient of the pixel points;

A meaning of the gradient in the image processing is a variation of the pixel value in which direction being the fastest, which is a maximum changing rate of the gray-scale of the image. At an edge part of the image, a fluctuation of the pixel value is more obvious; therefore, a detection of this kind of fluctuation can be implemented by applying a gradient calculating to the image.

Scan each pixel point in the image waiting for being processed line by line and column by column, to the pixel points, calculating its gradient first. Since the image in the computer is stored in the digital image form, which means the image is a discrete digital signal, apply the finite difference to the gradient of the digital image to replace the differential in the continuous signal.

The followings are several conventional image gradient template:

1) Roberts Gradient

Roberts gradient operator is a kind of the simplest operator, which is a kind of operator using a local difference operator to search the edge, taking the difference between two neighboring pixels in the diagonal direction being similar to the gradient amplitude to detect the edge. A result of detecting a vertical edge is better than an oblique edge, with high position accuracy, sensitive to noise, unable to suppress the noise influence.

2) Prewitt Gradient

| | | | | | |
|---|---|---|---|---|---|
| −1 | −1 | −1 | 1 | 0 | −1 |
| 0 | 0 | 0 | 1 | 0 | −1 |
| 1 | 1 | 1 | 1 | 0 | −1 |

The left side is a 3×3 Prewitt gradient template in the x direction, and the right side is a 3×3 Prewitt gradient template in the y direction.

3) Sobel Gradient

There are two Sobel gradient operators, one is for detecting a horizontal edge; the other one is for detecting the vertical edge. Comparing with the Prewitt operator, the Sobel operator weights the influence of the location of the pixel, which can lower the blurry degree of the edge, therefore, has better effect. The 3×3 template of the Sobel gradient operator are shown below:

| | | | | | |
|---|---|---|---|---|---|
| −1 | −2 | −1 | −1 | 0 | 1 |
| 0 | 0 | 0 | −2 | 0 | 2 |
| 1 | 2 | 1 | −1 | 0 | 1 |

The left side is a 3×3 Sobel gradient template in the x direction, and the right side is a 3×3 Sobel gradient template in the y direction.

4) Laplacian Gradient

Laplacian gradient operator is isotropic, which is regardless of the direction of the axis, the gradient is constant after the axis is rotated.

| | | | | | |
|---|---|---|---|---|---|
| 0 | −1 | 0 | −1 | −1 | −1 |
| −1 | 4 | −1 | −1 | 8 | −1 |
| 0 | −1 | 0 | −1 | −1 | −1 |

The left side is a template of a 4 neighborhoods system, the right side is a template of an 8 neighborhoods system.

5) Scharr Gradient

| | | | | | |
|---|---|---|---|---|---|
| −3 | 0 | 3 | 3 | 10 | 3 |
| −10 | 0 | 10 | 0 | 0 | 0 |
| −3 | 0 | 3 | −3 | −10 | −3 |

The left side is a 3×3 Scharr gradient template in the y direction, and the right side is a 3×3 Scharr gradient template in the x direction. The positions of the positive and negative signs in the operator are changed, location assignment of the quadrant in mathematic is satisfied when calculating the gradient direction, which seems to be more intuitive.

Take the calculating with the Sobel gradient template as an example, a distribution of one pixel point and the pixel value of its 3×3 neighborhood is shown below:

| | | |
|---|---|---|
| P1 | P2 | P 3 |
| P4 | P5 | P6 |
| P7 | P8 | P9 |

To the pixel point P5, the gradient value can be calculated with the formula below:

$$G = \sqrt{\begin{matrix}{⌊ ( p 3 - p 1 ) + 2 * ( p 6 - p 4 ) + ( p 9 - p 7 ) ⌋}^{2} + \\ {⌊ ( p 1 - p 7 ) + 2 * ( p 2 - p 8 ) + ( p 3 - p 9 ) ⌋}^{2}\end{matrix}}$$

Wherein, G is the gradient value corresponding to the pixel point P5, the range of G is [0, 4\sqrt{2}*255], P1˜P9 is the pixel value of all the pixel point in the 3×3 neighborhood.

The embodiments of the present disclosure are not limit to the type of the gradient operator taken to calculate the gradient value of the pixel point, any algorithm which can implement the calculation of the gradient value in the embodiments of the present disclosure are in the protection scope of the embodiments of the present disclosure.

Step 120: sharpen the pixel points if determining the gradient is larger than a predetermined gradient threshold value, and update pixel values of the pixel points with pixel values obtained from the sharpening.

In this step, firstly, determine whether the gradient value is larger than a threshold value, if over the predetermined threshold value, apply a sharpening to the pixel points, to avoid the maximum value and the minimum value after sharpening are over the pixel value range of the original image, and cause a perceptible gray scale mutation at the edge in the image.

Furthermore, combining FIG. 2, in step 120, apply a sharpening to the pixel points is implemented by step 121 to step 125.

Step 121: calculate gradient directions of the pixel points according to the gradients; according to the definition of the gradient direction, take the following formula to calculate the gradient direction θ of the pixel point:

$$θ = arctan ( \frac{{p}_{x}}{{p}_{y}} )$$

wherein, pₓ is the gradient value of the pixel point along the x direction, p_{y} is the gradient value of the pixel point along the y direction, arctan ( ) is an arctangent function.

Taking the Sobel operator as an example, the calculating of the pₓ and the pₓ are shown below:

Px=(p3−p1)+2*(p6−p4)+(p9−p7)

Py=(p1−p7)+2*(p2−p8)+(p3−p9)

In the embodiments of the present disclosure, the calculation of the gradient direction can be executed before determining whether apply the sharpening, also can be determining whether apply the sharpening process first, and then calculating the gradient direction, the embodiments of the present disclosure are not limited thereof.

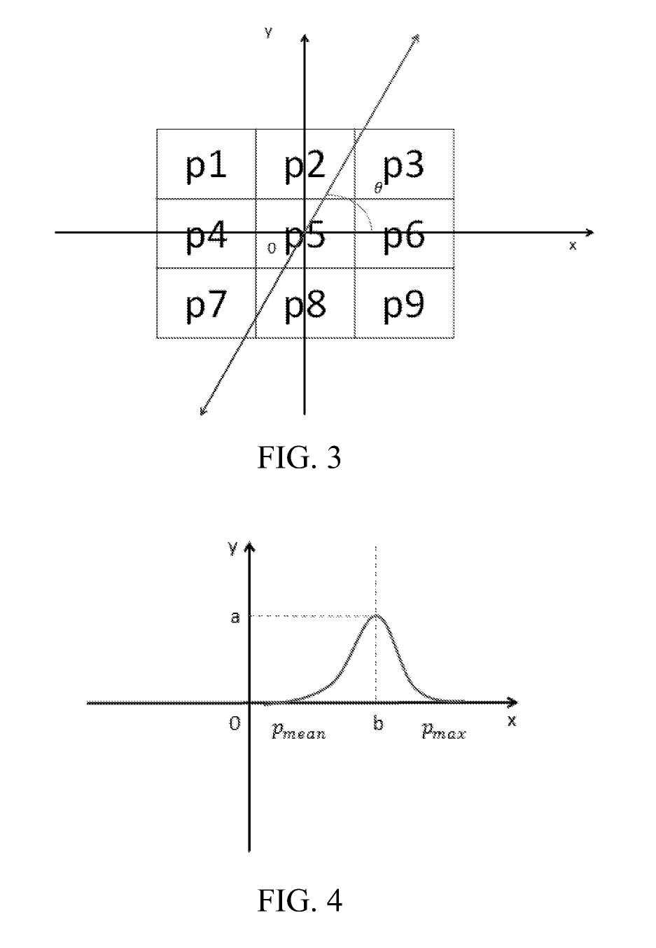

Step 122: find a maximal pixel value and a minimum pixel value in a neighborhood of the pixel points along a positive direction and a negative direction of the gradient direction. As shown in FIG. 3, take the pixel point as an origin of the coordinates, the horizontal direction is the x axis, the vertical direction is the y axis, draw a schematic view of an extension line of the gradient direction of the pixel point and the anti-direction in the neighborhood of the pixel point.

The positive direction and the negative direction of the gradient direction are the regions with the most perceptible pixel value variation of the image, therefore, search the maximum value and the minimum value of the pixel value along this direction in the neighborhood, the calculating amount is small, and is more precise. The maximal pixel value is noted as pₘₐₓ, and the minimum pixel value is noted as pₘᵢₙ.

Step 123: calculate an average pixel value in the neighborhood; a calculating formula of the average pixel value is shown below:

$${p}_{mean} = \{ {\sum }_{1}^{N * N} {p}_{x} \} / ( N * N )$$

wherein, pₘₑₐₙ is the average pixel value, N*N is a total number of the pixel points in the neighborhood, pₓ are the pixel values corresponding to each of the pixel points in the neighborhood.

Step 124: calculate the sharpening parameter according to the average pixel value, the maximal pixel value, and the minimum pixel value;
when p₅>pₘₑₐₙ, should approximate the value of p₅ toward pₘₐₓ, when pₛ is between pₘₑₐₙ and pₘₐₓ, the degree of the approximation should be the largest. p₅ comes closer to pₘₑₐₙ and pₘₐₓ, the degree of the sharpening should be smaller, to avoid the appearing of the saw tooth and the perceptible gray scale mutation, as shown in FIG. 4. Therefore, the embodiments of the present disclosure take the Gaussian function to calculate the sharpening parameter.

The Gaussian function is shown below:

f=a×exp [−(x−b)²/c²]

wherein, a, b, and c are experiential values. In ideal state, a should be 1.0, but for avoiding the situation like saw tooth, etc., normally take a=0.85 should be ok; the value of b is

b=(pₘₐₓ+pₘₑₐₙ)/2;

c is the parameter controlling the Gaussian width, by experiment, the width is most appropriate to mapping the width to the standard Gaussian function when c is 0.35, therefore,

c=(pₘₐₓ−pₘₑₐₙ)/0.35.

Step 125: sharpen the pixel points according to the sharpening parameter.

Take the formula below to sharpen the pixel points according to the sharpening parameter:

p′=p+f×(pₘₐₓ−p)

wherein, p′ is the pixel value obtained after sharpen the pixel point, p is the pixel value obtained before sharpening the pixel point, pₘₐₓ is the maximal pixel value, f is the sharpening parameter.

In this embodiment, detect the location in the image with larger gray-scale variation through the gradient calculation, to implement a quick and precise edge detection; with automatically limiting a range of the pixel values after sharpening, ensure that the maximum value and the minimum value of the pixel value after image sharpening still in the range of the original value during the image sharpening, so as to effectively eliminate the visual perceptible gray scale mutation.

In addition, calculate the sharpening parameter on the basis of the magnitude of the pixel value in the neighborhood of the pixel point with the Gaussian function, implement that self-adaptively adjust the degree of the image sharpening, improves the image quality.

### Second Embodiment

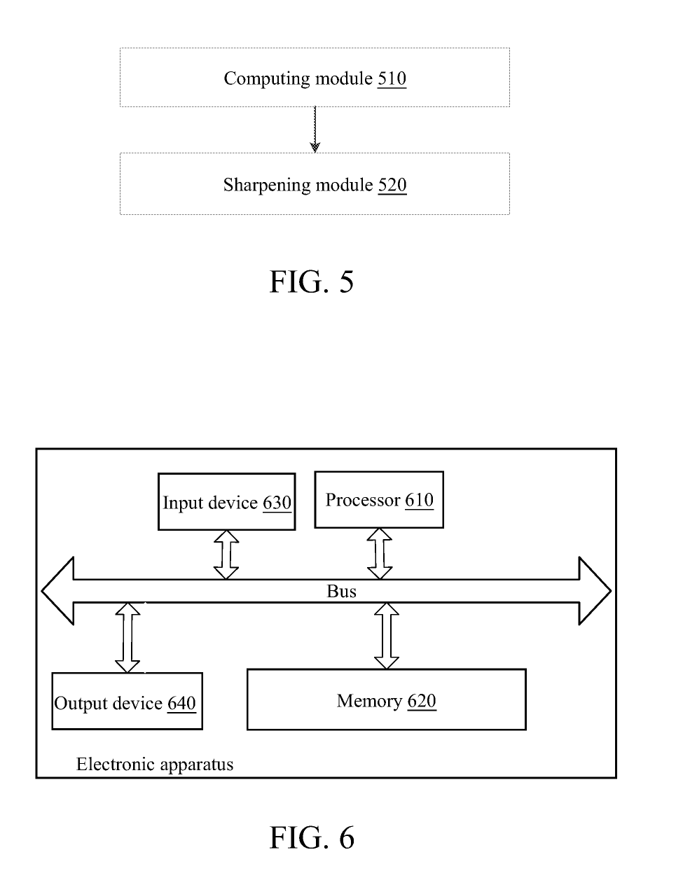

FIG. 5 is a structural schematic view of an apparatus in accordance with a second embodiment of the present disclosure, combining FIG. 5, the embodiment of the present disclosure is a gradient value and gradient direction based image sharpening device, mainly including two big modules: a calculating module 510 and a sharpening module 520.
The calculating module 510 is for scanning pixel points in an image one by one and calculating a gradient of the pixel points;
the sharpening module 520 is for sharpening the pixel points if determining the gradient being larger than a predetermined gradient threshold value, and updating pixel values of the pixel points with pixel values obtained from the sharpening.

Specifically, the sharpening module 520 is further for: calculating a gradient direction of the pixel points according to the gradient; finding a maximal pixel value and a minimum pixel value in a neighborhood of the pixel points along a positive direction and a negative direction of the gradient direction.

Specifically, the sharpening module 520 is further for: calculating an average pixel value in the neighborhood; calculating the sharpening parameter according to the average pixel value, the maximal pixel value, and the minimum pixel value; sharpen the pixel points according to the sharpening parameter.

Specifically, the sharpening module 520 is further for: taking the following formula to calculate the sharpening parameter:

f=a×exp [−(x−b)²/c²]

wherein, a, b, and c are experiential values, b and c are calculated according to the maximal pixel value and the average pixel value.

Specifically, the sharpening module 520 is further for: taking the following formula to sharpen the pixel points according to the sharpening parameter:

p′=p+f×(pₘₐₓ−p)

wherein, p′ is a pixel value obtained from the pixel point after sharpening, p is a pixel value obtained from the pixel point before sharpening, pₘₐₓ is the maximal pixel value, and f is the sharpening parameter.

The device shown in FIG. 5 can exploit the method shown in the embodiment in FIG. 1 to FIG. 4, and the principle and technical effects can refer to the embodiment shown in FIG. 1 to FIG. 4, which will not be repeated hereafter.

The apparatus described in above embodiments are merely illustrative, wherein the unit described as a separate member may or may not be physically separate, as part of the display unit may or may not be physical units, i.e., it may be located in one place, or may be distributed to multiple network elements. You can select some or all of the modules to achieve the purpose of the present example of the embodiments according to the actual needs. Those of ordinary skill in the art without paying any creative work that can be understood and implemented.

### Third Embodiment

An embodiment of the present disclosure provides a non-volatile computer storage medium. The computer storage medium stores computer-executable instructions, and the computer-executable instructions can carry out the gradient value and gradient direction based image sharpening method in any one of the method embodiments.

### Fourth Embodiment

FIG. 6 is a structural schematic view of an electronic apparatus in accordance with another embodiment of the present disclosure.

The apparatus includes: one or multiple processor(s) 610 and a memory 620. The number of the processor 610 is one in FIG. 6 as an example.

The apparatus for executing the gradient value and gradient direction based image sharpening method can further includes: an input device 630 and an output device 640.

The processor 610, the memory 620, the input device 630, and the output device 640 can be connected to each other via a bus or other members for electrical connection. In FIG. 6, they are connected to each other via the bus in this embodiment.

The memory 620 is one kind of non-volatile computer-readable storage mediums applicable to store non-volatile software programs, non-volatile computer-executable programs and modules; for example, the program instructions and the function modules corresponding to the gradient value and gradient direction based image sharpening method in the embodiments (i.e. the computing module 510 and the sharpening module 520 shown in FIG. 5). The processor 610 executes function disclosures and data processing of the server by running the non-volatile software programs, non-volatile computer-executable programs and modules stored in the memory 620, and thereby the gradient value and gradient direction based image sharpening method in the aforementioned embodiments are achievable.

The memory 620 can include a program storage area and a data storage area, wherein the program storage area can store an operating system and at least one disclosure program required by a function; the data storage area can store the data created according to the usage of the device for displaying a menu on apparatus. Furthermore, the memory 620 can include a high speed random-access memory, and further include a non-volatile solid state memory such as at least one disk storage member, at least one flash memory member and other non-volatile solid state storage member. In some embodiments, the memory 620 can have a remote connection with the processor 610, and such remote memory can be connected to the device for displaying a menu on apparatus by a network. The aforementioned network includes, but not limited to, internet, intranet, local area network, mobile communication network and combination thereof.

The input device 630 can receive digital or character information, and generate a key signal input corresponding to the user setting and the function control of the gradient value and gradient direction based image sharpening method. The output device 640 can include a displaying unit such as screen.

The one or more modules are stored in the memory 620. When the one or more modules are executed by one or more processor 610, the method for displaying a menu on apparatus disclosed in any one of the embodiments is performed.

The aforementioned product can execute the method provided in the embodiment of the present disclosure, having the function modules and beneficial effects corresponding to execute the method. The technical details which are not clearly described in this embodiment can be referred to the method provided in the embodiments of the present disclosure.

The electronic apparatus in the embodiments of the present disclosure is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are calculating and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatuses: audio, video player (e.g. iPod), handheld game console, e-books, as well as smart toys and portable vehicle-mounted navigation apparatus.

(4) Server: an apparatus provide calculating service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The above-described apparatus embodiments are merely illustrative, wherein units described as separate parts may or may not be physically separated, part as display unit may or may not be a physical unit, which may be located in one place, or can be distributed to multiple network elements. You can select some or all of the modules to achieve the purpose of the present embodiment according to the actual requirements.

Through the above description of the implementation manners, a person skilled in the art can clearly understand that, the aspects of the present disclosure may be achieved in a manner of combining software and a necessary common hardware platform, and certainly may also be achieved by hardware. Based on such understanding, the technical solutions of the aspects of the present disclosure can be reflected in a form of a software product. The computer software product is stored in a computer readable storage medium such as ROM/RAM, hard disk, CD, etc., includes several instructions to make a computer device (which may be a personal computer, a server, a network device, or the like) execute the method described in the embodiments or a part of the embodiments.

While we have shown and described the embodiment in accordance with the present invention,

Finally, it should be noted that: the above embodiments are merely to illustrate the technical solutions of the present disclosure, but not intended to limit; although the present disclosure has been described in detail refer to the above embodiments, it should be clear to those skilled in the art that the technical solutions in the above embodiments can be amended, or a part of the technical features can be equivalently replaced; these amendments and replacements will not make the spirit of the corresponding technical solution departing from the spirit and the scope of the present invention.

What is claimed is:

1. An image sharpening method based on a gradient value and a gradient direction, applied at an electronic apparatus, comprising:
scanning pixel points in an image one by one, and calculating gradients of pixel points;
sharpening the pixel points if determining the gradient is larger than a predetermined gradient threshold value, and updating pixel values of the pixel points with pixel values obtained from the sharpening.

2. The method according to claim 1, wherein the sharpening the pixel points comprises:
calculating gradient directions of the pixel points according to the gradients;
finding a maximal pixel value and a minimum pixel value in a neighborhood of the pixel points along a positive direction and a negative direction of the gradient direction.

3. The method according to claim 2, wherein the sharpening the pixel points comprises:
calculating an average pixel value in the neighborhood;
calculating a sharpening parameter according to the average pixel value, the maximal pixel value, and the minimum pixel value;
sharpening the pixel points according to the sharpening parameter.

4. The method according to claim 3, wherein the calculating the sharpening parameter comprises:
calculating the sharpening parameter by a formula below:
f=a×exp [−(x−b)²/c²]
wherein, a, b, and c are experiential values, b and c are calculated according to the maximal pixel value and the average pixel value.

5. The method according to claim 3, wherein the sharpening the pixel points according to the sharpening parameter adopts a formula below:
p′=p+f×(pₘₐₓ−p)
wherein, p′ is a pixel value obtained from the pixel point after sharpening, p is a pixel value obtained from the pixel point before sharpening, pₘₐₓ is the maximal pixel value, and f is the sharpening parameter.

6. A non-volatile computer storage medium, storing computer-executable instructions, the computer-executable instructions are for:
scanning pixel points in an image one by one, and calculating gradients of pixel points;
sharpening the pixel points if determining the gradient is larger than a predetermined gradient threshold value, and updating pixel values of the pixel points with pixel values obtained from the sharpening.

7. An electronic apparatus, comprising:
at least one processor; and
a memory communicatively connected to the at least one processor; wherein,
the memory stores instructions which is executable by the at least one processor, the instructions are executed by the at least one processor, and the at least one processor being able to:
scanning pixel points in an image one by one, and calculating gradients of pixel points;
sharpening the pixel points if determining the gradient is larger than a predetermined gradient threshold value, and updating pixel values of the pixel points with pixel values obtained from the sharpening.

8. The non-volatile computer storage medium according to claim 6, wherein the sharpening the pixel points comprises:
calculating gradient directions of the pixel points according to the gradients;
finding a maximal pixel value and a minimum pixel value in a neighborhood of the pixel points along a positive direction and a negative direction of the gradient direction.

9. The non-volatile computer storage medium according to claim 8, wherein the sharpening the pixel points comprises:
calculating an average pixel value in the neighborhood;
calculating a sharpening parameter according to the average pixel value, the maximal pixel value, and the minimum pixel value;
sharpening the pixel points according to the sharpening parameter.

10. The non-volatile computer storage medium according to claim 9, wherein the calculating the sharpening parameter comprises:
calculating the sharpening parameter by a formula below:
f=a×exp [−(x−b)²/c²]
wherein, a, b, and c are experiential values, b and c are calculated according to the maximal pixel value and the average pixel value.

11. The non-volatile computer storage medium according to claim 9 or claim 10, wherein the sharpening the pixel points according to the sharpening parameter comprises:
sharpening the pixel points adopting a formula below according to the sharpening parameter:
p′=p+f×(pₘₐₓ−p)
wherein, p′ is a pixel value obtained from the pixel point after sharpening, p is a pixel value obtained from the pixel point before sharpening, pₘₐₓ is the maximal pixel value, and f is the sharpening parameter.

12. The electronic apparatus according to claim 7, wherein the sharpening the pixel points comprises:
calculating gradient directions of the pixel points according to the gradients;
finding a maximal pixel value and a minimum pixel value in a neighborhood of the pixel points along a positive direction and a negative direction of the gradient direction.

13. The electronic apparatus according to claim 12, wherein the sharpening the pixel points comprises:
calculating an average pixel value in the neighborhood;
calculating a sharpening parameter according to the average pixel value, the maximal pixel value, and the minimum pixel value;
sharpening the pixel points according to the sharpening parameter.

14. The electronic apparatus according to claim 13, wherein calculating the sharpening parameter comprises:
calculating the sharpening parameter by a formula below:
f=a×exp [−(x−b)²/c²]
wherein, a, b, and c are experiential values, b and c are calculated according to the maximal pixel value and the average pixel value.

15. The electronic apparatus according to claim 13, wherein the sharpening the pixel points according to the sharpening parameter comprises:
sharpening the pixel points by a formula below according to the sharpening parameter:
p′−p+f×(pₘₐₓ−p)
wherein, p′ is a pixel value obtained from the pixel point after sharpening, p is a pixel value obtained from the pixel point before sharpening, pₘₐₓ is the maximal pixel value, and f is the sharpening parameter.
